(19) United States
(12) Patent Application Publication
(10) Pub. No.: US 2025/0270390 A1
(43) Pub. Date: Aug. 28, 2025

(54) Composite And Method For Producing Composite

(71) Applicant: SEIKO EPSON CORPORATION, Tokyo (JP)

(72) Inventor: Takenori SAWAI, Shiojiri (JP)

(21) Appl. No.: 19/062,266

(22) Filed: Feb. 25, 2025

(30) Foreign Application Priority Data
Feb. 26, 2024 (JP) 2024-026256

(51) Int. Cl. C08L 5/08; C08K 5/053; C08L 1/02; C08L 3/04

(52) U.S. Cl. CPC C08L 5/08; C08K 5/053; C08L 1/02; C08L 3/04; C08L 2205/03; C08L 2205/06; C08L 2205/16; C08L 2312/00

(57) ABSTRACT

A composite contains: mushroom hyphae; starch; a plasticizer; a crosslinking agent; and a fiber. It is preferable that a starch composite particle in a form of a particle is contained, and the starch and the plasticizer are contained in the starch composite particle. Further, the crosslinking agent is preferably contained in the starch composite particle. The starch composite particle preferably has an average particle diameter of 1 μm or more and 60 μm or less.

The present application is based on, and claims priority from JP Application Serial Number 2024-026256, filed Feb. 26, 2024, the disclosure of which is hereby incorporated by reference herein in its entirety.

### BACKGROUND

### 1. Technical Field

The present disclosure relates to a composite and a method for producing a composite.

### 2. Related Art

In recent years, there has been a growing demand in a market for products that use natural materials as products having a low environmental impact. For example, JP-A-2021-155655 discloses a composite that uses fibers, plasticizers and starch to reduce use of petroleum-derived materials.

However, starch plasticized with a plasticizer has high hygroscopic properties. Therefore, for example, when the composite is placed in a high-humidity environment, the plasticized starch may soften and mechanical strength of the composite may decrease. There is room for improvement in texture of the composite, and there is also a problem that applications of the composite are limited. Therefore, there is a demand for achieving a composite having excellent mechanical strength and moisture resistance and good texture.

### SUMMARY

A composite according to an application example in the present disclosure contains: mushroom hyphae; starch; a plasticizer; a crosslinking agent; and a fiber.

A method for producing a composite according to an application example in the present disclosure, which is a method for producing the composite according to the application example in the present disclosure, includes: defibrating a mushroom mycelium to obtain the hyphae; and mixing the hyphae, the starch, the plasticizer, the crosslinking agent, and the fiber to obtain the composite.

A method for producing a composite according to an application example in the present disclosure, which is a method for producing the composite according to the application example in the present disclosure, includes: preparing a medium including the starch, the plasticizer, the crosslinking agent, and the fiber; inoculating the medium with an inoculum of the hyphae; and culturing the inoculum to obtain the composite.

### BRIEF DESCRIPTION OF THE DRAWINGS

FIG. 1 is a schematic diagram of starch composite particles dispersed in hyphae and fibers.

FIG. 2 is a process diagram showing a configuration of a method for producing a composite according to an embodiment.

FIG. 3 is a diagram schematically showing an example of a composite producing device for producing the composite according to the embodiment.

FIG. 4 is a process diagram showing a configuration of a modification of the method for producing a composite according to the embodiment.

FIG. 5 is Table 1 showing configurations of composites in Examples and Comparative Examples and configurations of starch composite particles used in production of the composites.

FIG. 6 is Table 2 showing configurations of composites in Examples and Comparative Examples and configurations of starch composite particles used in production of the composites.

FIG. 7 is Table 3 showing configurations of composites in Examples and Comparative Examples and configurations of starch composite particles used in production of the composites.

FIG. 8 is Table 4 showing configurations of composites in Examples and Comparative Examples and configurations of starch composite particles used in production of the composites.

FIG. 9 is Table 5 showing configurations of composites in Examples and Comparative Examples and configurations of starch composite particles used in production of the composites.

FIG. 10 is Table 6 showing configurations of composites in Examples and Comparative Examples and configurations of starch composite particles used in production of the composites.

FIG. 11 is Table 7 showing configurations of composites in Examples and Comparative Examples and configurations of starch composite particles used in production of the composites.

### DESCRIPTION OF EMBODIMENTS

Hereinafter, a composite and a method for producing a composite according to the present disclosure will be described in detail based on preferred embodiments shown in the accompanying drawings.

### 1. Composite

First, a composite according to an embodiment will be described.

The composite according to the embodiment contains: mushroom hyphae; starch; a plasticizer; a crosslinking agent; and a fiber.

### 1.1. Mushroom Hyphae

The mushroom hyphae have a fibrous structure constituting mycelium of mushroom. A type of the mushroom is not particularly limited, and examples thereof include Agaricus arvensis, Agrocybe brasiliensis, Amylomyces rouxii, species of Amy lomyces, Armillaria mellea, Aspergillus nidulans, Aspergillus niger, Aspergillus oryzae, Ceriporia lacerata, Coprinus comatus, Fibroporia vaillantii, Fistulina hepatica, Flammulina velutipes, Fomitopsis officinalis, Ganoderma sessile, Ganoderma tsugae, Hericium erinaceus, Hypholoma capnoides, Hypholoma sublaterium, Inonotus obliquus, Lactarius chrysorrheus, Macrolepiota procera, Morchella angusticeps, Myceliophthora thermophila, Neurospora crassa, Penicillium camembertii, Penicillium chrysogenum, Penicillium rubens, Phycomyces blakesleeanus, Pleurotus djamor, Pleurotus ostreatus, Polyporus squamosus, Psathyrella aquatica, Rhizopus microspores, Rhizopus oryzae, Schizophyllum commune, Streptomyces venezuelae, Stropharia rugosoannulata, Thielavia terrestris, Ustilago maydis, Shiitake mushroom (Lentinula genus), Meripilus giganteus (Meripilus genus), Grifola frondosa (Grifola genus), Leucopaxillus giganteus (Leucopaxillus genus), polyporaceae (Fomitopsis genus), and Tricholoma matsutake (Tricholoma genus).

The mushroom hyphae may aggregate with each other to form a mycelium. That is, a part or all of hyphae in the composite may be a mycelium formed by the aggregation of the hyphae. In the following description, mushroom hyphae are also simply referred to as “hyphae”.

An average diameter of the hyphae is preferably set to be smaller than an average diameter of fibers. Accordingly, smooth texture derived from the hyphae is easily imparted to the composite.

The average diameter of the hyphae is not particularly limited, and is preferably 0.1 μm or more and 10.0 μm or less, and more preferably 0.3 μm or more and 5.0 μm or less. If the average diameter of hyphae is within the range, texture of the composite can be particularly enhanced.

The average diameter of the hyphae is measured as follows.

First, the composite is magnified and observed so that 100 or more hyphae are contained in one image, and an image is acquired. Next, 10 or more hyphal images are randomly selected, and a width of a hyphal image is measured. Then, an average value of measured values is taken as the average diameter of the hyphae.

An average length of the hyphae is not particularly limited, and is preferably 0.001 mm or more and 3.0 mm or less, more preferably 0.010 mm or more and 2.0 mm or less, and still more preferably 0.050 mm or more and 1.0 mm or less. If the average length of the hyphae is within the range, for example, when the composite is molded into a sheet, the hyphae are oriented along a surface of the composite, and the hyphae are moderately entangled with each other. Accordingly, the texture of the composite can be particularly enhanced.

The average length of the hyphae is measured as follows.

First, the composite is magnified and observed so that 100 or more hyphae are contained in one image, and an image is acquired. Next, 10 or more hyphal images are randomly selected, and a maximum length that can be taken in the hyphal image is measured. Then, an average value of measured values is taken as the average length of the hyphae.

The hyphae preferably contain chitin. The chitin is contained as a component of a cell wall constituting the hyphae. The chitin is a high-molecular polysaccharide having N-acetylglucosamine in which an acetamide group is added to glucose as a structural unit. Since the chitin has a hydroxy group, presence of the chitin in the hyphae e makes it easier for the hyphae to be crosslinked by a crosslinking agent.

### 1.2. Starch

The starch is a molecule obtained by polymerizing a plurality of α-glucose molecules through glycosidic bonds. The starch may be a straight chain molecule or may contain a branch. As the starch, it is possible to use, for example, starches derived from various plants. More specifically, it is possible to use, for example, a material derived from cereals such as corn, wheat, and rice, beans such as broad beans, mung beans, and adzuki beans, tubers such as potato, sweet potato, and tapioca, wild plants such as bracken and kudzu, and palm trees such as sago palm.

The starch may be modified starch. Examples of the modified starch include acetylated adipic acid crosslinked starch, acetylated starch, oxidized starch, sodium octenyl succinate, hydroxypropyl starch, hydroxypropylated phosphate crosslinked starch, phosphorylated starch, phosphate-esterified phosphate crosslinked starch, urea phosphate-esterified starch, sodium starch glycolate, and high amylose corn starch. The starch may be modified starch. Examples of the modified starch include those obtained by processing or modifying starch, and specific examples thereof include dextrin.

A weight average molecular weight of the starch is not particularly limited, and is preferably 50000 or more and 400000 or less, more preferably 70000 or more and 300000 or less, and still more preferably 80000 or more and 280000 or less. When the molecular weight is within this range, mixing of starch and a plasticizer can be made more excellent. Accordingly, even when water is not present or only a small amount of water is present, plasticization by heating proceeds more easily, and strength and productivity of the composite can be made excellent.

The weight average molecular weight of the starch can be determined by measurement using gel permeation chromatography. In this case, polystyrene is used as a standard substance.

The composite may contain starch composite particles in a form of particles. The starch composite particles contain at least starch and a plasticizer. By taking the form of starch composite particles, the starch and plasticizer can be distributed evenly. Accordingly, homogenization of the composite is achieved, and moisture resistance and mechanical strength of the composite can be enhanced. There may be starch or a plasticizer not contained in the starch composite particles.

An average particle diameter of the starch composite particles is not particularly limited, and is preferably 1 μm or more and 60 μm or less, more preferably 1 μm or more and 50 μm or less, still more preferably 2 μm or more and 30 μm or less, and particularly preferably 2 μm or more and 20 μm or less. When the average particle diameter of the starch composite particles is within the range, in the composite, a dispersion state between the hyphae or between the fibers of the starch composite particles is likely to be more uniform, and a composite having better mechanical strength, moisture resistance, and texture can be obtained.

The average particle diameter of the starch composite particles is, for example, a particle diameter D50 when a cumulative frequency from a small diameter side in a volume-based particle size distribution is 50% as measured by a particle size distribution measuring device using a laser diffraction scattering method as a measurement principle. An example of the particle size distribution measuring device is Microtrac MT3000II manufactured by Nikkiso Co., Ltd.

### 1.3. Plasticizer

The plasticizer has a property of plasticizing starch. The plasticizer is preferably contained in the starch composite particles and contributes to plasticization of starch. When starch is plasticized with the plasticizer, the starch exhibits thermoplasticity. In the present specification, such plasticized starch may be referred to as “thermoplastic starch”, “plasticized starch”, or the like.

Examples of the plasticizer include sugar alcohols. The plasticizer is preferably one or more selected from sugar alcohols. When the plasticizer is selected from sugar alcohols, plasticization of starch can occur more easily. Accordingly, it is easier for the starch composite particles to bind the hyphae to each other, the fibers to each other, and the hyphae and the fibers, thereby imparting better strength to the composite.

The sugar alcohol is a kind of sugar produced by reducing a carbonyl group of aldose or ketose. Examples of the sugar alcohol include maltitol, lactitol, tetritol, pentitol, hexitol, erythritol, sorbitol, xylitol, and mannitol. Among these, one or more selected from the sorbitol, erythritol and D-mannitol are more preferable.

Among the sugar alcohols, sorbitol, erythritol, and D-mannitol can more easily cause plasticization of starch and, further, do not cause plasticization at room temperature, which facilitates handling during a production process and handling of a produced composite. Accordingly, it is easier for the starch composite particles to bind the hyphae to each other, the fibers to each other, and the hyphae and the fibers, thereby imparting better mechanical strength to the composite.

On the other hand, polyglycerin may be used as the plasticizer. The polyglycerin is obtained by polymerizing glycerol, and a degree of polymerization is not particularly limited. Further, as the plasticizer, any compound containing many hydroxy groups is considered to have a property of plasticizing starch, and such a compound may be used.

A content of the plasticizer is preferably 0.05 or more and 0.90 or less, more preferably 0.10 or more and 0.85 or less, and still more preferably 0.10 or more and 0.80 or less in mass ratio with respect to a total content of the starch and the plasticizer. When the content of the plasticizer is within the range, plasticization of the starch becomes more sufficient, and better mechanical strength can be imparted to the composite.

### 1.4. Crosslinking Agent

The crosslinking agent reacts with hydroxy groups in hyphae, starch, a plasticizer and a fiber when heat is applied. Accordingly, the crosslinking agent contributes to these crosslinks and can improve the mechanical strength and moisture resistance of the composite. In particular, since the crosslinking agent is crosslinked with the hyphae, the texture of the composite can be particularly improved.

The crosslinking agent is an organic compound having two or more carboxy groups. The crosslinking agent is preferably contained in the starch composite particles and contributes to good retention of the starch composite particles.

The crosslinking agent is not particularly limited as long as the crosslinking agent is an organic compound having a plurality of carboxy groups. Examples of the crosslinking agent include aliphatic dicarboxylic acids such as oxalic acid, malonic acid, succinic acid, glutaric acid, adipic acid, pimelic acid, suberic acid, azelaic acid, and sebacic acid; aromatic dicarboxylic acids such as phthalic acid, isophthalic acid, and terephthalic acid; dicarboxylic acids having a hydroxy group such as tartaric acid and malic acid; tricarboxylic acids such as citric acid and aconitic acid; and amino acids having a plurality of carboxy groups such as aspartic acid and glutamic acid. One or a mixture of two or more of these may be used.

The crosslinking agent is preferably one or more selected from dicarboxylic acids, mainly from a viewpoint of reactivity with a hydroxy group. The dicarboxylic acid can form ester bonds with hydroxy groups of the hyphae, starch, plasticizer, and fiber, and can chemically crosslink between the fiber and starch, fiber and fiber, starch and starch, hyphae and fiber, hyphae and starch, and hyphae and hyphae. In particular, when both the starch and the plasticizer are present as in the starch composite particle, the crosslinking agent is crosslinked with the starch via the plasticizer. Accordingly, the mechanical strength, moisture resistance, and texture of the composite can be improved. The ester bond (chemical bond) can be confirmed by FTIR.

The crosslinking agent is more preferably one or more selected from succinic acid, adipic acid, and sebacic acid among the dicarboxylic acids. Accordingly, since the above-described chemical crosslinking is formed by the ester bond, the mechanical strength, moisture resistance, and texture of the composite can be further improved.

A content of the crosslinking agent is preferably 0.01 or more and 0.60 or less, more preferably 0.01 or more and 0.50 or less, still more preferably 0.05 or more and 0.20 or less, and particularly preferably 0.10 or more and 0.20 or less in mass ratio with respect to a total content of the starch, the plasticizer, and the crosslinking agent. When the content of the crosslinking agent is within the range, a degree of chemical crosslinking described above is further improved, and thus mechanical strength, moisture resistance, and texture of the composite can be further improved.

### 1.5. Production of Starch Composite Particle

The starch composite particles are formed by, for example, a spray drying method. The spray drying method is not particularly limited, and a known method can be used. Since the starch composite particles contain a plasticizer, it is preferable to apply heat as little as possible during spray drying.

In the spray drying method, starch, a plasticizer, and a crosslinking agent are mixed with water, and if necessary, heat is applied to the mixture to prepare a gelatinized liquid. A heating temperature is preferably 100° C. or lower, more preferably 98° C. or lower, and still more preferably 95° C. or lower. When preparing the gelatinized liquid, if water solubility of the crosslinking agent is low, the starch and the plasticizer may be mixed with water and heated as necessary to prepare a gelatinized liquid, and the crosslinking agent may be dissolved in a suitable water-soluble organic solvent such as ethanol, and the resulting solution may be mixed with the gelatinized liquid and subjected to spray drying.

When the starch composite particles are prepared by the spray drying method, it is possible to adjust a size and a shape of the obtained starch composite particles by appropriately adjusting a supply rate, an inlet temperature, an outlet temperature, a residence time, the number of revolutions of an atomizer, a spray pressure, and the like of the mixed liquid (gelatinized liquid).

In the spray drying method, a temperature of an inlet (the inlet temperature) through which the solution is introduced into a spray dryer is preferably 100° C. or higher and 200° C. or lower, more preferably 110° C. or higher and 190° C. or lower, and even more preferably 120° C. or higher and 180° C. or lower. In the spray drying method, a temperature of an outlet (the outlet temperature) through which the solution is sprayed and discharged is preferably 40° C. or higher and 100° C. or lower, more preferably 50° C. or higher and 90° C. or lower, and even more preferably 60° C. or higher and 80° C. or lower.

The spray dryer is not particularly limited, and for example, ADL311S-A manufactured by Yamato Scientific Co., Ltd. can be used.

### 1.6. Fiber

The fiber is not particularly limited, and a wide range of fiber materials can be used. Examples of the fibers include natural fibers such as animal fibers and plant fibers, and chemical fibers such as organic fibers, inorganic fibers, and organic-inorganic composite fibers. Specifically, at least one selected from the group consisting of cellulose, silk, wool, cotton, hemp, kenaf, flax, ramie, jute, Manila hemp, sisal, a coniferous tree, and a broad leaf tree is preferably used. These may be used alone, may be appropriately mixed and used, or may be used as regenerated fibers subjected to purification or the like.

Examples of a raw material for the fiber include waste paper and old cloth, and it is sufficient that the raw material contains at least one of the above fibers. The fibers may be subjected to various surface treatments. A material for the fiber may be a pure substance or a material containing a plurality of components such as impurities, additives, and other components.

Among these, fibers containing cellulose are more preferable. The cellulose contains a large number of hydroxy groups in a molecular structure. Therefore, a reaction with the crosslinking agent is also likely to occur, and the mechanical strength and moisture resistance of the composite are likely to be improved.

The average diameter of the fibers is not particularly limited, and is preferably larger than the average diameter of hyphae. Specifically, the average diameter of the fibers is preferably 1.0 μm or more and 100.0 μm or less, and more preferably 3.0 μm or more and 50.0 μm or less. If the average diameter of the fibers is within the range, the mechanical strength of the composite can be particularly enhanced.

The average diameter of the fibers is measured as follows.

First, the composite is magnified and observed so that 100 or more fibers are contained in one image, and an image is acquired. Next, 10 or more fiber images are randomly selected, and a width of a fiber image is measured. Then, an average value of measured values is taken as the average diameter of the fibers.

An average length of the fibers is not particularly limited, and is preferably 0.001 mm or more and 5.0 mm or less, more preferably 0.002 mm or more and 3.0 mm or less, and still more preferably 0.003 mm or more and 2.0 mm or less. If the average length of the fibers is within the range, for example, the fibers are oriented along the surface of the composite, and the fibers are moderately entangled with each other. Accordingly, the mechanical strength of the composite can be particularly enhanced.

The average length of the fibers is measured as follows.

First, the composite is magnified and observed so that 100 or more fibers are contained in one image, and an image is acquired. Next, 10 or more fiber images are randomly selected, and a maximum length that can be taken in the fiber image is measured. Then, an average value of measured values is taken as the average length of the fibers.

### 1.7. Molding of Composite

The composite is formed by, for example, mixing hyphae, starch, a plasticizer, a crosslinking agent, and a fiber, and heating the mixture. In particular, the starch, plasticizer, and crosslinking agent preferably constitute starch composite particles. Such starch composite particles have thermoplasticity and also have reactivity due to a crosslinking agent. Therefore, heating the mixture physically binds the hyphae to each other, the hyphae and the fibers, and the fibers to each other. By heating the mixture, hydroxy groups present in the hyphae, starch, plasticizer and fiber react with the crosslinking agent to chemically bond to each other.

A mixing ratio of the hyphae, fiber, and starch composite particle in the composite can be appropriately set according to application and required performance of the composite. The mixing ratio of the hyphae, fiber, and starch composite particle can be expressed by, for example, a total content of the starch, plasticizer, and crosslinking agent in the composite, and a ratio of a content of hyphae to a content of fibers.

Among these, the total content of the starch, plasticizer, and crosslinking agent in the composite is preferably 1.0 mass % or more and 90.0 mass % or less, more preferably 1.5 mass % or more and 85.0 mass % or less, still more preferably 1.5 mass % or more and 80.0 mass % or less, and particularly preferably 5.0 mass % or more and 80.0 mass % or less. If the total content of the starch, plasticizer, and crosslinking agent in the composite is within the range, the mixing ratio of the hyphae, fiber, and starch composite particle is optimized, and sufficient mechanical strength, moisture resistance, and texture are obtained.

A mass ratio of the content of hyphae to the content of fibers is preferably 0.10 or more and 9.0 or less, more preferably 0.20 or more and 5.0 or less, and still more preferably 0.30 or more and 3.0 or less. If the ratio of the content of hyphae to the content of fibers is within the range, it is possible to balance high mechanical strength and good texture in the composite.

When the mass ratio of the content of hyphae to the content of fibers is below the above lower limit value, the texture of the composite may decrease. On the other hand, when the mass ratio of the content of hyphae to the content of fibers exceeds the above upper limit value, the mechanical strength of the composite may decrease.

The composite may contain any additive. Examples of the additives include an antioxidant, an ultraviolet absorber, a lubricant, a flame retardant, an antistatic agent, and a filler, and one or two or more thereof are used.

### 1.8. Dispersion of Starch Composite Particle in Composite

In the composite, the starch composite particles are preferably dispersed in hyphae or fibers. A dispersed state refers to a state in which starch composite particles are interspersed between hyphae, between fibers, and between hyphae and fibers. As described above, the composite is formed by heating. Therefore, in the composite, the starch composite particles are present in a solidified state after plasticization.

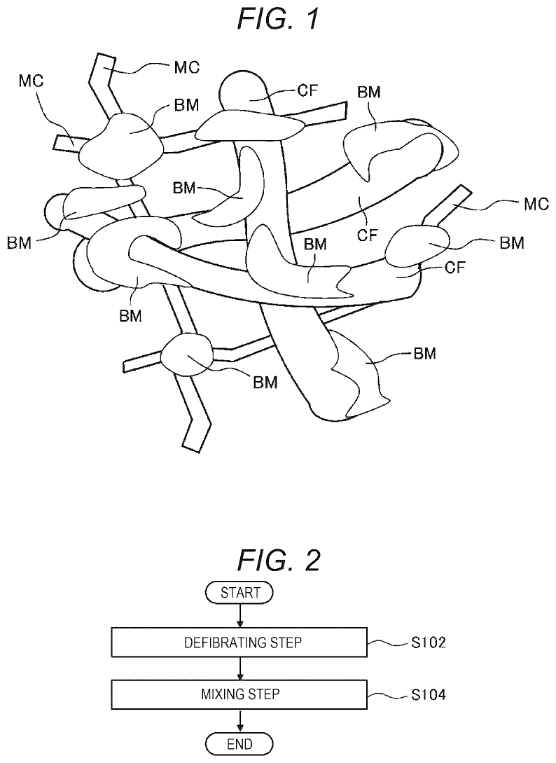

FIG. 1 is a schematic diagram of starch composite particles BM dispersed in hyphae MC and fibers CF. As shown in FIG. 1, in the composite, the starch composite particles BM lose a shape of the particles before melting, and are present in a fixed state, as if adhering to the hyphae MC and the fiber CF. In this state, the hyphae MC are physically bound together, the fibers CF are physically bound together, the hyphae MC and fibers CF are physically bound together, as well as chemically bonded by a crosslinking agent, thereby fixing a positional relationship thereof. That is, the hyphae MC are strongly bound to each other, the fibers CF are strongly bound to each other, and the hyphae MC and fibers CF are strongly bound to each other via the starch composite particles BM. Accordingly, the composite can maintain a desired shape such as a sheet by fixing and maintaining an outer shape of the composite. Since the hyphae MC and fibers CF spread so as to be entangled with each other, good texture is imparted to the composite.

In the composite, the hyphae MC or fibers CF that are not bound may be present, and a ratio thereof can be adjusted by a blending amount of the starch composite particles. The more portions of the hyphae MC and fibers CF that are not bound together, the more easily the resulting composite is deformed. The more the bound portions, the greater rigidity and mechanical strength of the resulting composite.

### 1.9. Use of Composite

The composite can be molded into various shapes as necessary. The composite can be molded into a two-dimensional shape such as a sheet, board, or web, or a three-dimensional shape such as a block, rod, or sphere. Typical examples of the composite include paper, nonwoven fabric, wallpaper, wrapping paper, colored paper, paper for drawing, a fiber board, a filter, a liquid absorbent, a sound absorber, a cushioning material, and a mat.

Since the composite according to the embodiment is excellent in mechanical strength, moisture resistance, and texture, the composite is particularly useful as a natural material such as a leather substitute material (substitute leather).

### 2. Method for Producing Composite

Next, the method for producing a composite according to the embodiment will be described.

FIG. 2 is a process diagram showing a configuration of the method for producing a composite according to the embodiment.

The method for producing a composite shown in FIG. 2 includes a defibrating step S102 and a mixing step S104.

### 2.1. Defibrating Step

In the defibrating step S102, a mushroom mycelium is defibrated. Accordingly, the mycelium can be disentangled and hyphae can be removed.

The mycelium is an aggregate of hyphae. A method of imparting mechanical energy, for example, is used for defibration of mycelium. In particular, by using a defibration machine, a mycelium can be defibrated to obtain hyphae while reducing significant damage to the hyphae. A defibrating method may be a wet method, but a dry method is preferably used. The dry method refers to a method of defibration in air such as the atmosphere, rather than in a liquid such as water. As the defibration machine, an impeller mill capable of dry defibration is preferably used.

### 2.2. Mixing Step

In mixing step S104, the hyphae, starch, plasticizer, crosslinking agent, and fiber are mixed. Accordingly, a composite is obtained.

For mixing, various stirrers are used. Examples of the stirrer include a mechanical stirrer, an airflow stirrer, and an ultrasonic stirrer.

A timing of mixing the above components may be the same for each component or may be different for each component. For example, two or more components may be simultaneously mixed, or the components may be sequentially mixed.

The obtained composite may be molded as necessary. Accordingly, a composite having a desired shape can be obtained.

### 3. Composite Producing Device

Next, an example of a producing device to which the above-described producing method is applied will be described.

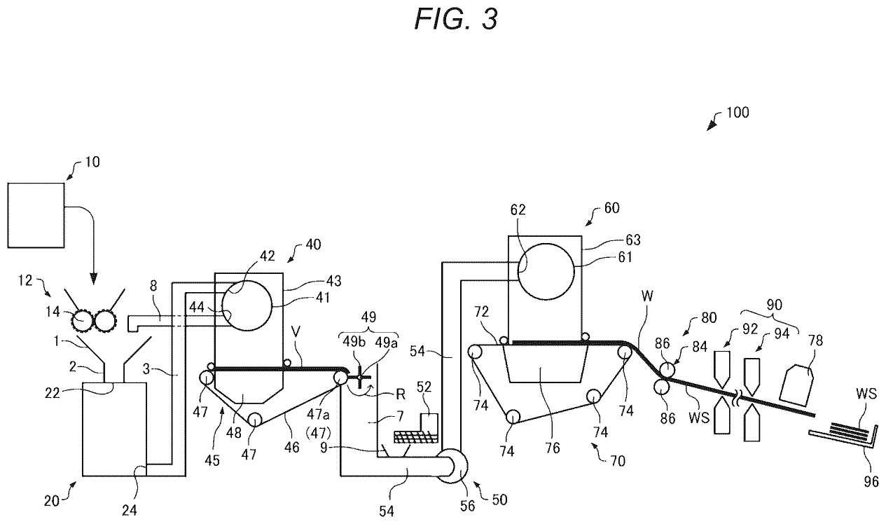

FIG. 3 is a diagram schematically showing an example of a composite producing device 100 for producing a composite according to the embodiment.

The composite producing device 100 shown in FIG. 3 has a supply unit 10, a coarse crushing unit 12, a defibration unit 20, a sorting unit 40, a first web forming unit 45, a rotating body 49, a mixing unit 50, a deposition unit 60, a second web forming unit 70, a composite forming unit 80, a cutting unit 90, and a humidifying unit 78.

The supply unit 10 supplies a raw material to the coarse crushing unit 12. The supply unit 10 is, for example, an automatic feeding unit for continuously feeding raw materials into the coarse crushing unit 12. The raw material supplied to the coarse crushing unit 12 may be any material containing fibers.

The coarse crushing unit 12 cuts the raw material supplied by the supply unit 10 into small pieces in air, such as the atmosphere (air). A shape and size of the small piece are, for example, a few centimeters square. In the illustrated example, the coarse crushing unit 12 has a coarse crushing blade 14, and the supplied raw material can be cut by the coarse crushing blade 14. As the coarse crushing unit 12, for example, a shredder is used. The raw material cut by the coarse crushing unit 12 is received by a hopper 1 and then transferred (transported) to the defibration unit 20 via a pipe 2.

The defibration unit 20 defibrates the raw material and the mushroom mycelium cut by the coarse crushing unit 12. The defibration unit 20 also has a function of separating substances such as resin particles, ink, toner, filler, and bleeding inhibitor attached to the raw material from the fibers.

The material that passes through the defibration unit 20 is referred to as “defibrated material”. The “defibrated material” may contain, in addition to the defibrated fiber and hyphae, resin particles separated when the fiber is defibrated, colorants such as ink, toner, or pigments, and an additive such as a bleeding inhibitor or a paper strengthening agent.

The defibration unit 20 performs defibration by a dry method. The defibration unit 20 has a function of generating an air flow for sucking a raw material, a mycelium, and the like and discharging a defibrated material. Accordingly, the defibration unit 20 can use the air flow generated by the defibration unit 20 to suck in the raw material and the like from an inlet 22 together with the air flow, defibrate the raw material and the like, and transport the defibrated material to an outlet 24. The defibrated material that passes through the defibration unit 20 is transferred to the sorting unit 40 via a pipe 3. The air flow for transporting the defibrated material from the defibration unit 20 to the sorting unit 40 may be an air flow generated by the defibration unit 20, or an airflow generator such as a blower may be provided and that air flow may be used.

The sorting unit 40 introduces the defibrated material defibrated by the defibration unit 20 from the inlet 42, and sorts the defibrated material according to a length of the fiber. The sorting unit 40 has a drum portion 41 and a housing 43 that houses the drum portion 41. As the drum portion 41, for example, a sieve is used. The drum portion 41 has a mesh (filter, screen), and can separate fibers or particles that are smaller than a size of a mesh opening (first sorted material that passes through the mesh) from fibers, undefibrated pieces, and lumps that are larger than the size of the mesh opening (second sorted material that does not pass through the mesh). For example, the first sorted material is transferred to the mixing unit 50 through a pipe 7. The second sorted material is returned to the defibration unit 20 from an outlet 44 through the pipe 8. Specifically, the drum portion 41 is a cylindrical sieve driven to rotate by a motor. As the mesh of the drum portion 41, for example, a wire mesh, an expanded metal obtained by stretching a metal plate having a slit, or a punched metal obtained by forming a hole in a metal plate by a press or the like is used.

The first web forming unit 45 transports the first sorted material that passes through the sorting unit 40 to the mixing unit 50. The first web forming unit 45 includes a mesh belt 46, tension rollers 47, and a suction unit 48 (suction mechanism).

The suction unit 48 sucks the first sorted material that passes through openings (openings of the mesh) of the sorting unit 40 and disperses in the air onto the mesh belt 46. The first sorted material is deposited on the moving mesh belt 46 and forms a web V. Basic configurations of the mesh belt 46, tension roller 47, and suction unit 48 are similar to those of a mesh belt 72, tension roller 74, and suction mechanism 76 of the second web forming unit 70 to be described below.

By passing through the sorting unit 40 and the first web forming unit 45, the web V is formed into a soft and puffy state containing a lot of air. The web V deposited on the mesh belt 46 is fed into the pipe 7 and transported to the mixing unit 50.

The rotating body 49 can cut the web V before the web V is transported to the mixing unit 50. In the illustrated example, the rotating body 49 includes a base portion 49a and a protruding portion 49b protruding from the base portion 49a. The protruding portion 49b has, for example, a plate shape. In the illustrated example, four protruding portions 49b are provided at equal intervals. As the base portion 49a rotates in a direction R, the protruding portion 49b rotates about the base portion 49a. By cutting the web V with the rotating body 49, for example, it is possible to reduce variations in an amount of defibrated material supplied to the deposition unit 60 per unit time.

The rotating body 49 is disposed near the first web forming unit 45. In the illustrated example, the rotating body 49 is provided near the tension roller 47a located downstream in a path of the web V. The rotating body 49 is disposed at a position where the protruding portion 49b can come into contact with the web V and does not come into contact with the mesh belt 46 on which the web V is deposited. A shortest distance between the protruding portion 49b and the mesh belt 46 is, for example, 0.05 mm or longer and 0.5 mm or shorter.

The mixing unit 50 mixes the first sorted material that passes through the sorting unit 40 and an additive containing starch composite particles. The mixing unit 50 has an additive supply unit 52 that supplies an additive, a pipe 54 that transports the first sorted material and additive, and a blower 56. In the illustrated example, the additive is supplied from the additive supply unit 52 to the pipe 54 via a hopper 9. The pipe 54 is continuous with the pipe 7.

In the mixing unit 50, an air flow is generated by the blower 56, and the first sorted material and additive can be transported while being mixed in the pipe 54. A mechanism for mixing the first sorted material and the additive is not particularly limited, and may be one that uses a blade rotating at a high speed to stir the mixture, or one that utilizes rotation of a container such as a V-type mixer.

As the additive supply unit 52, a screw feeder as shown in FIG. 3, a disk feeder (not shown), or the like is used. The additive supplied from the additive supply unit 52 includes the starch composite particles BM described above. At a time when the starch composite particles BM are supplied, the fibers and the hyphae are not bound. The starch composite particles BM are plasticized and crosslinked when passing through the composite forming unit 80, thereby binding the fibers and hyphae together in the composite WS.

When the starch composite particles BM do not contain a crosslinking agent, the crosslinking agent is supplied as the above additive. For example, when the crosslinking agent is in powder form, the starch composite particles BM and the crosslinking agent may be supplied from the additive supply unit 52. On the other hand, when the crosslinking agent is in a liquid state, a sprayer or the like may be provided at any position before reaching a heating unit 84, and the crosslinking agent may be sprayed onto the fibers.

The additives supplied from the additive supply unit 52 may contain, in addition to the starch composite particles BM, a colorant for coloring the fibers, an aggregation inhibitor for preventing aggregation of the fibers and hyphae and aggregation of the starch composite particles BM, and a flame retardant for making the fibers and the like difficult to burn, depending on a type of the composite WS to be produced. The mixture (mixture of the first sorted material and additive) that passes through the mixing unit 50 is transferred to the deposition unit 60 through the pipe 54.

The deposition unit 60 introduces the mixture that passes through the mixing unit 50 from an inlet 62, loosens the tangled defibrated material, and causes the defibrated material to fall while being dispersed in the air. Accordingly, the deposition unit 60 can deposit the mixture in the second web forming unit 70 with good uniformity.

The deposition unit 60 includes a drum portion 61 and a housing 63 that houses the drum portion 61. As the drum portion 61, a rotating cylindrical sieve is used. The drum portion 61 has a mesh, and causes fibers, hyphae, or particles that are contained in the mixture that passes through mixing unit 50 and that are smaller in size than an opening of the mesh to fall. The configuration of the drum portion 61 is, for example, the same as the configuration of the drum portion 41.

The “sieve” of the drum portion 61 may not have a function of sorting a specific object. That is, the drum portion 61 may cause all of the introduced mixture to fall.

The second web forming unit 70 deposits a passed material that passes through the deposition unit 60, and forms a web W that is a deposit that becomes the composite WS. The second web forming unit 70 includes, for example, the mesh belt 72, the tension rollers 74, and the suction mechanism 76.

While moving, the mesh belt 72 deposits the passed material that passes through openings (openings of the mesh) of the deposition unit 60. The mesh belt 72 is stretched by the tension rollers 74, and is configured to be impermeable to a passed material but permeable to air. The mesh belt 72 moves as the tension rollers 74 rotate. The web W is formed on the mesh belt 72 as a result of the passed material that passes through the deposition unit 60 continuously falling while the mesh belt 72 continuously moves. The mesh belt 72 is made of metal, resin, cloth, or nonwoven fabric, for example.

The suction mechanism 76 is disposed below the mesh belt 72 (at an opposite side of the deposition unit 60). The suction mechanism 76 can generate a downward air flow (air flow from the deposition unit 60 to the mesh belt 72). A mixture dispersed in the air by the deposition unit 60 can be sucked onto the mesh belt 72 by the suction mechanism 76. Accordingly, a discharge speed from the deposition unit 60 can be increased. Further, a downflow can be formed in a falling path of the mixture by the suction mechanism 76, and it is possible to prevent the defibrated material and the additive from being entangled during falling.

The composite forming unit 80 heats the web W deposited on the mesh belt 72 to form the composite WS. In the composite forming unit 80, heat is applied to the deposit (web W) of the mixture of the defibrated material and the additive mixed in the web W, thereby plasticizing the starch composite particles BM and causing a crosslinking reaction. Thereafter, the starch composite particles BM physically and chemically bind a plurality of cellulose fibers together.

The composite forming unit 80 includes the heating unit 84 that heats the web W. As the heating unit 84, for example, a heat press or a heating roller (heater roller) is used, and the following description will be given using an example in which a heating roller (heater roller) is used. The number of heating rollers in the heating unit 84 is not particularly limited. In the illustrated example, the heating unit 84 includes a pair of heating rollers 86. By implementing the heating unit 84 as the heating roller 86, the composite WS can be formed while the web W is being continuously transported. The heating rollers 86 are disposed, for example, such that rotation axes thereof are parallel to each other.

The heating roller 86 comes into contact with the web W and heats the web W while sandwiching and transporting the web W. The heating roller 86 transports the web W while sandwiching the web W, and forms the composite WS having a predetermined thickness. A pressure applied to the web W by the heating roller 86 can be adjusted according to the composite WS to be produced.

A surface temperature of the heating roller 86 when heating the web W is appropriately set according to a plasticization temperature of the starch composite particles BM and a reaction temperature of the crosslinking agent, and is, for example, 60.0° C. or higher and 250.0° C. or lower, preferably 70.0° C. or higher and 220.0° C. or lower, and more preferably 80.0° C. or higher and 200.0° C. or lower.

The composite WS (the composite according to the embodiment) can be produced by such a composite producing device 100.

The composite producing device 100 may include the cutting unit 90 as necessary. In the illustrated example, the cutting unit 90 is provided downstream of the heating unit 84. The cutting unit 90 cuts the composite WS formed by the composite forming unit 80. In the illustrated example, the cutting unit 90 includes a first cutting unit 92 that cuts the composite WS in a direction intersecting a transporting direction of the composite WS, and a second cutting unit 94 that cuts the composite WS in a direction parallel to the transporting direction. The second cutting unit 94 cuts, for example, the composite WS that passed through the first cutting unit 92.

The composite producing device 100 may also include the humidifying unit 78. In the illustrated example, the humidifying unit 78 is provided downstream of the cutting unit 90 and upstream of a discharge unit 96. The humidifying unit 78 can impart water or water vapor to the composite WS. Specific modes of the humidifying unit 78 include, for example, a mode in which a mist of water or an aqueous solution is sprayed, a mode in which water or an aqueous solution is sprayed, and a mode in which water or an aqueous solution is ejected from an ink jet head and adhered.

Since composite producing device 100 includes the humidifying unit 78, it is possible to make the formed composite WS wet. Accordingly, the fibers and hyphae become soft with moisture. Therefore, when the composite WS is used to form a three-dimensional container or the like, wrinkles and tears are even less likely to occur. By imparting moisture to the composite WS, it becomes easier to form hydrogen bonds between the fibers and between the hyphae, so that density of a molded container or the like is increased, and for example, mechanical strength thereof can be improved.

The starch composite particles are plasticized by heat, and a crosslinking reaction occurs, so that a dry composite can be formed. Therefore, the humidifying unit 78 is not necessarily required in the composite producing device 100. The humidifying unit may be disposed at an appropriate position in order to expect the formation of hydrogen bonds between the fibers and between the hyphae.

Thus, the composite WS is molded. The produced composite WS is cut by, for example, the cutting unit 90, and the composite WS is discharged to the discharge unit 96 as necessary. The composite WS may be wound in a roll shape without being cut.

In the above example, an example of producing a sheet-shaped composite WS is shown, but it is also possible to form a three-dimensional composite by changing a heating unit, a deposition unit, or the like.

### 4. Modification of Method for Producing Composite

Next, a modification of the method for producing a composite according to the embodiment will be described.

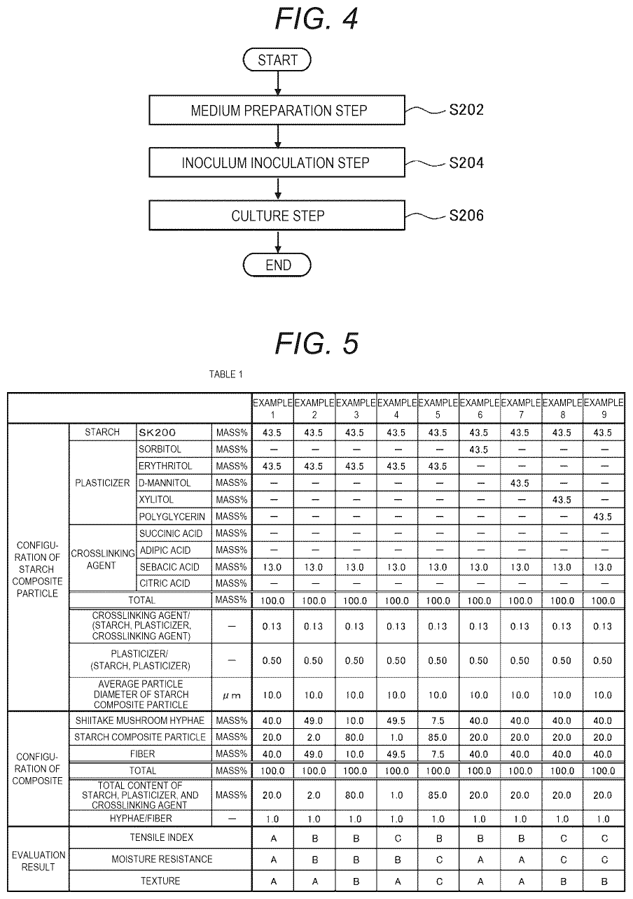

FIG. 4 is a process diagram showing a configuration of the modification of the method for producing a composite according to the embodiment.

The method for producing a composite shown in FIG. 4 includes a medium preparation step S202, an inoculum inoculation step S204, and a culture step S206.

### 4.1. Medium Preparation Step

In the medium preparation step S202, a medium containing starch, a plasticizer, a crosslinking agent, and fibers is prepared. In addition to these components, the medium may contain a nutrient, a gelling agent, and the like necessary for growth of mushroom hyphae. On the other hand, starch may be used as a nutrient.

The medium may be a solid medium or a liquid medium.

Of the solid medium and the liquid medium, the solid medium is obtained by molding a mixture containing, for example, starch, a plasticizer, a crosslinking agent, and fibers into a predetermined shape. At this time, it is preferable to mold the composite into a shape to be produced. Finally, a composite having a desired shape can be efficiently produced without performing secondary processing. A configuration of the solid medium may be, for example, a configuration in which hyphae are removed from the composite described above, and an additive such as a nutrient is added.

The liquid medium includes, for example, starch, a plasticizer, a crosslinking agent, and fibers dispersed in a dispersion medium such as water. A configuration of the liquid medium may be, for example, a configuration in which hyphae are removed from the composite described above, and an additive such as a nutrient and a dispersion medium are added.

### 4.2. Inoculum Inoculation Step

In the inoculum inoculation step S204, an inoculum of hyphae is inoculated into the medium. A method of inoculation is not particularly limited.

For example, in a case of inoculation into a solid medium, an inoculum may be placed on a surface of the solid medium or embedded in the solid medium. The inoculum may be disposed at equal intervals or may be disposed at random intervals.

In a case of inoculation into the liquid medium, the liquid medium to which the inoculum is added may be stirred.

### 4.3. Culture Step

In the culture step S206, the inoculum inoculated in the medium is cultured to obtain a composite. Accordingly, a composite can be obtained in which hyphae grow from the inoculum and are spread over the entire medium. The hyphae form a three-dimensional network. Accordingly, in a case of the solid medium, voids present in the medium can be filled with hyphae, and flexible mechanical properties derived from mycelium can be imparted to the composite. When a solid medium is used, the obtained composite can be used as it is. On the other hand, in a case of a liquid medium, solid-liquid separation may be performed after culture to remove a liquid component. When a liquid medium is used, the medium is relatively easy to manage and handle because the medium is liquid. In the liquid medium, since an operation such as stirring is possible, it is easy to make culture uniform and speed up.

Culture conditions such as a culture temperature, a culture time, and humidity are appropriately set in accordance with a type of the hyphae or the medium.

A solid portion of the liquid medium subjected to solid-liquid separation after culture, or the liquid medium after culture may be poured directly onto a surface of a separately prepared solid medium. Accordingly, the cultured hyphae can be implanted to the solid medium to some extent. As a result, a composite having both good mechanical strength and moisture resistance derived from the solid medium and good texture derived from the hyphae can be produced in a relatively short time.

The obtained composite may be molded as necessary. Accordingly, a composite having a desired shape can be obtained.

### 5. Effects of Embodiment

As described above, the composite according to the embodiment contains: mushroom hyphae; starch; a plasticizer; a crosslinking agent; and a fiber.

According to such a configuration, a composite having excellent mechanical strength and moisture resistance, and good texture can be obtained.

The composite according to the embodiment contains a starch composite particle in a form of a particle. The starch and the plasticizer are contained in the starch composite particle.

According to such a configuration, the starch and plasticizer can be uniformly distributed. Accordingly, homogenization of the composite is achieved, and moisture resistance and mechanical strength of the composite can be enhanced.

In the composite according to the embodiment, the crosslinking agent is contained in the starch composite particle.

According to such a configuration, the starch composite particle is well retained. Accordingly, the moisture resistance and mechanical strength of the composite can be enhanced.

In the composite according to the embodiment, the average particle diameter of the starch composite particles is 1 μm or more and 60 μm or less.

According to such a configuration, in the composite, a dispersion state of the starch composite particles between hyphae or between fibers tends to be more uniform. Accordingly, a composite having better mechanical strength, moisture resistance, and texture can be obtained.

In the composite according to the embodiment, the fiber contains cellulose.

According to such a configuration, since the cellulose contains a large number of hydroxy groups in the molecular structure, reaction with the crosslinking agent is also likely to occur, and the mechanical strength and moisture resistance of the composite are likely to be improved.

In the composite according to the embodiment, the crosslinking agent is crosslinked with the starch via the plasticizer.

According to such a configuration, the crosslinking agent contributes to crosslinking of the hyphae, starch, plasticizer, and fiber, and can improve the mechanical strength, moisture resistance, and texture of the composite.

In the composite according to the embodiment, the crosslinking agent is crosslinked with the hyphae.

According to such a configuration, the texture of the composite can be particularly improved.

In the composite according to the embodiment, the hyphae have an average diameter of 0.1 μm or more and 10.0 μm or less.

According to such a configuration, the texture of the composite can be particularly enhanced.

In the composite according to the embodiment, the fiber has an average diameter of 1.0 μm or more and 100.0 μm or less.

According to such a configuration, the mechanical strength of the composite can be particularly enhanced.

In the composite according to the embodiment, the mass ratio of the content of hyphae to the content of fibers is 0.10 or more and 9.0 or less.

According to such a configuration, it is possible to balance high mechanical strength and good texture of the composite.

In the composite according to the embodiment, the total content of the starch, the plasticizer, and the crosslinking agent is 1.0 mass % or more and 90.0 mass or less.

According to such a configuration, the composite can have sufficient mechanical strength.

In the composite according to the embodiment, the plasticizer is one or more selected from sugar alcohols.

According to such a configuration, it is possible to more easily cause plasticization of the starch. Accordingly, it is easier for the starch composite particles to bind the hyphae to each other, the fibers to each other, and the hyphae and the fibers, thereby imparting better strength to the composite.

In the composite according to the embodiment, the sugar alcohol is one or more selected from sorbitol, erythritol, and D-mannitol.

According to such a configuration, plasticization of starch can be more easily caused and, further, since no plasticization occurs at room temperature, handling during a production process and handling of a produced composite are facilitated. Accordingly, it is easier for the starch composite particles to bind the hyphae to each other, the fibers to each other, and the hyphae and the fibers, thereby imparting better mechanical strength to the composite.

In the composite according to the embodiment, the mass ratio of the content of the plasticizer to the total content of the plasticizer and starch is 0.05 or more and 0.90 or less.

According to such a configuration, plasticization of the starch becomes more sufficient, and better mechanical strength can be imparted to the composite.

In the composite according to the embodiment, the crosslinking agent is one or more selected from dicarboxylic acids.

According to such a configuration, the hyphae, starch, plasticizer, and fiber can be chemically crosslinked. Accordingly, the mechanical strength, moisture resistance, and texture of the composite can be improved.

In the composite according to the embodiment, the dicarboxylic acid is one or more selected from succinic acid, adipic acid, and sebacic acid.

According to such a configuration, since the chemical crosslinking is formed by the ester bond, the mechanical strength, moisture resistance, and texture of the composite can be further improved.

The method for producing a composite according to the embodiment, which is the method for producing the composite according to the embodiment, includes the defibrating step S102 and the mixing step S104. In the defibrating step S102, the mushroom mycelium is defibrated to obtain hyphae. In the mixing step S104, the hyphae, starch, plasticizer, crosslinking agent, and fiber are mixed to obtain a composite.

According to such a configuration, a composite having excellent mechanical strength and moisture resistance and good texture can be produced.

The method for producing a composite according to the embodiment, which is the method for producing the composite according to the embodiment, includes the medium preparation step S202, the inoculum inoculation step S204, and the culture step S206. In the medium preparation step S202, a medium containing starch, a plasticizer, a crosslinking agent, and a fiber is prepared. In the inoculum inoculation step S204, an inoculum of hyphae is inoculated into the medium. In the culture step S206, the inoculum is cultured to obtain a composite.

According to such a configuration, a composite having excellent mechanical strength and moisture resistance, and good texture can be produced. The hyphae can form a three-dimensional network and fill voids in the medium, thereby imparting the composite with flexible mechanical properties derived from the mycelium.

In the method for producing a composite according to the embodiment, the medium is a solid medium or a liquid medium.

According to such a configuration, when a solid medium is used, the obtained composite can be used as it is. When a liquid medium is used, management and handling of the medium are relatively easy.

Although the composite and the method for producing a composite in the present disclosure have been described above based on preferred embodiments, the present disclosure is not limited thereto. For example, in the composite according to the present disclosure, each part of the embodiment may be replaced with any component having a similar function, or any component may be added to the embodiment.

The method for producing a composite according to the present disclosure may be one in which any desired process is added to the above embodiment.

### EXAMPLES

Next, specific examples of the present disclosure will be described.

### 6. Production of Starch Composite Particle

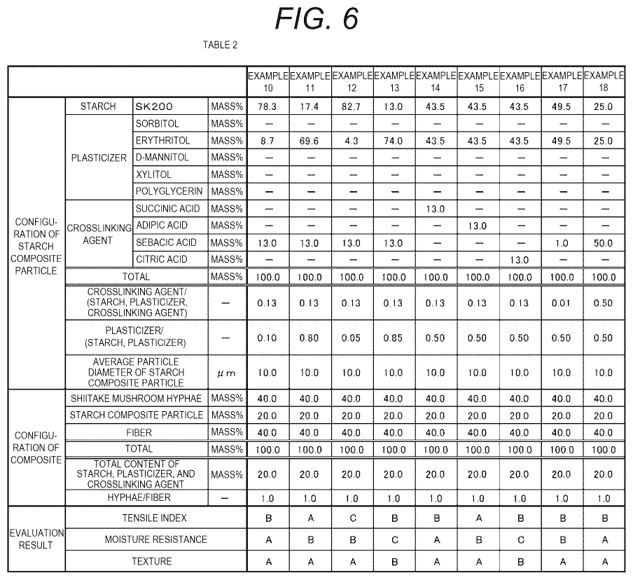

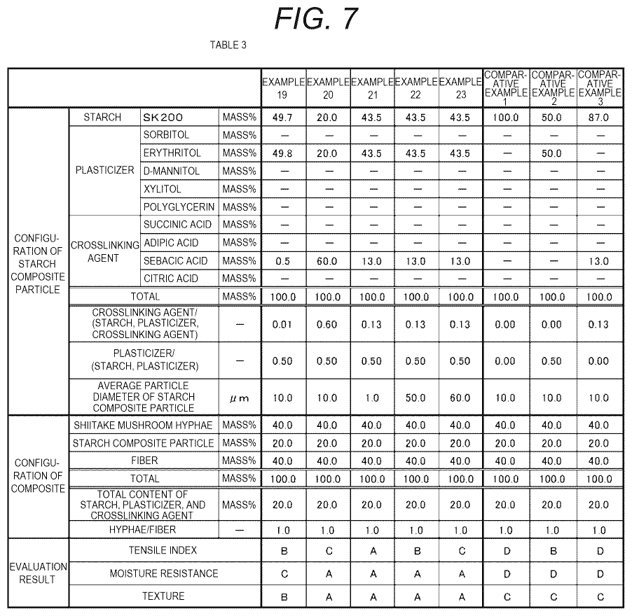

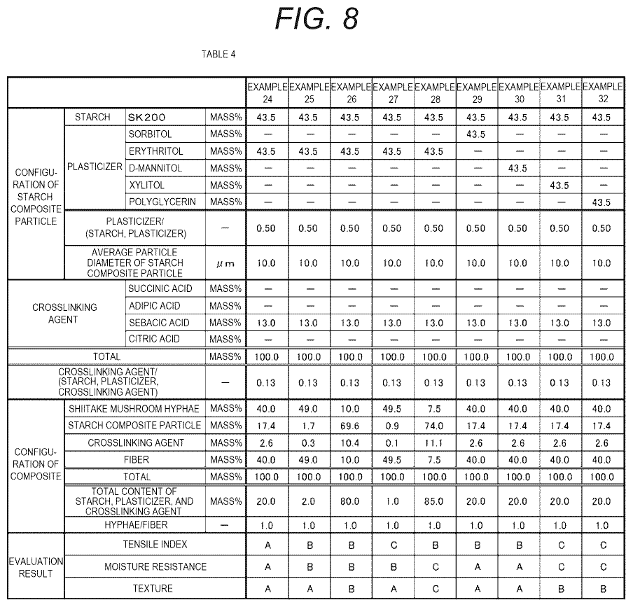

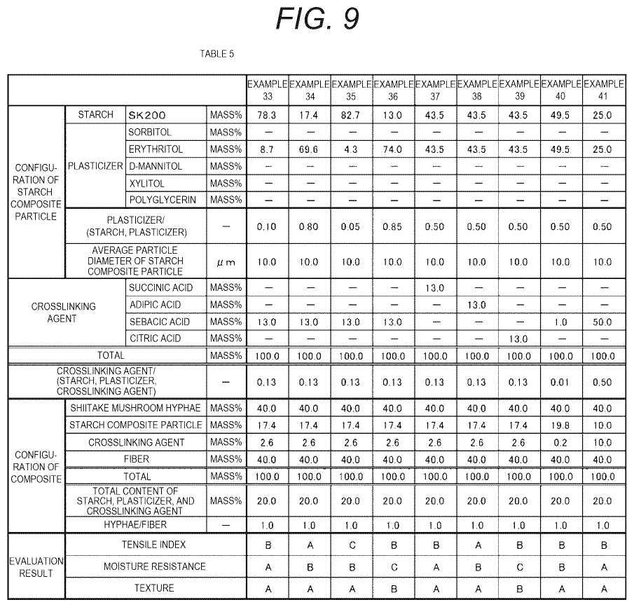

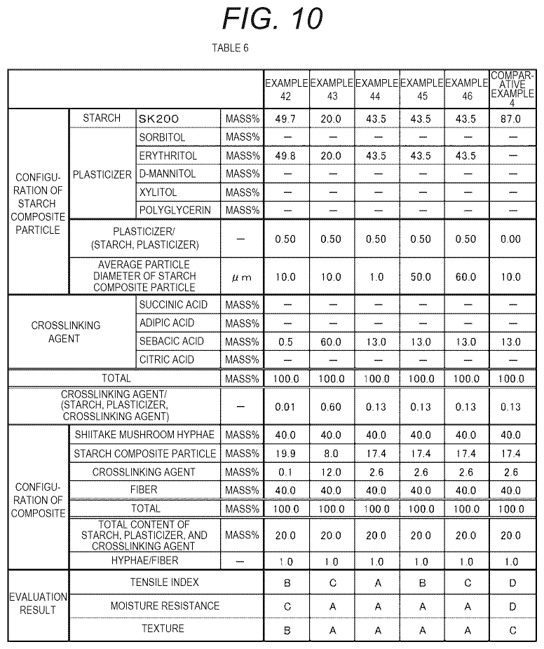

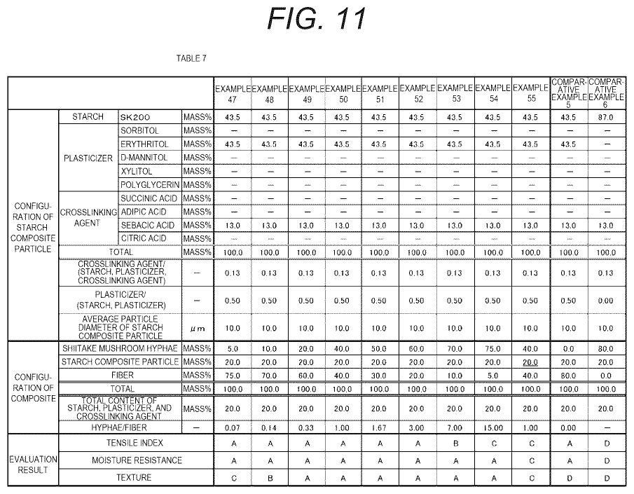

Starch composite particles used in Examples and Comparative Examples were produced as follows. FIGS. 5 to 11 are Tables 1 to 7 showing configurations of composites in Examples and Comparative Examples and configurations of starch composite particles used in production of the composites. FIG. 5 (Table 1) to FIG. 7 (Table 3) and FIG. 11 (Table 7) show examples in which starch composite particles containing a crosslinking agent were produced. Example 55 is an example in which starch composite particles are not used. FIG. 8 (Table 4) to FIG. 10 (Table 6) show examples in which starch composite particles not containing a crosslinking agent were produced.

### 6.1. When Containing Succinic Acid or Citric Acid as Plasticizer

First, an oxidized starch (SK 200, manufactured by Japan Corn Starch Co., Ltd.) as starch, a plasticizer, succinic acid or citric acid (manufactured by Fujifilm Wako Pure Chemical Industries, Ltd.) as a crosslinking agent, and water were mixed, and the mixture was heated and stirred at 100° C. for 2 hours to prepare a starch gelatinized liquid. The obtained starch gelatinized liquid was spray-dried at an inlet temperature of 150° C. and an outlet temperature of 70° C. using a spray dryer (ADL311S-A, manufactured by Yamato Scientific Co., Ltd.) to obtain starch composite particles.

### 6.2. When Containing Adipic Acid or Sebacic Acid as Plasticizer

First, an oxidized starch (SK 200, manufactured by Japan Corn Starch Co., Ltd.) as starch, a plasticizer, and water were mixed, and the mixture was heated and stirred at 100° C. for 2 hours to prepare a starch gelatinized liquid.

Separately, 2 mass % of adipic acid or sebacic acid (manufactured by Tokyo Chemical Industry Co., Ltd.) was mixed with ethanol (manufactured by Tokyo Chemical Industry Co., Ltd.) to prepare an ethanol solution of adipic acid and an ethanol solution of sebacic acid.

Then, the starch gelatinized liquid and the ethanol solution of adipic acid or the ethanol solution of sebacic acid were mixed at a mass ratio of 1:1 to obtain a mixed liquid.

The obtained mixed liquid was spray-dried at an inlet temperature of 150° C. and an outlet temperature of 70° C. using a spray dryer (ADL311S-A, manufactured by Yamato Scientific Co., Ltd.) to obtain starch composite particles.

### 6.3. When Starch Composite Particles Do Not Contain Crosslinking Agent

First, an oxidized starch (SK 200, manufactured by Japan Corn Starch Co., Ltd.) as starch, a plasticizer, and water were mixed, and the mixture was heated and stirred at 100° C. for 2 hours to prepare a starch gelatinized liquid. The obtained starch gelatinized liquid was spray-dried at an inlet temperature of 150° C. and an outlet temperature of 70° C. using a spray dryer (ADL311S-A, manufactured by Yamato Scientific Co., Ltd.) to obtain starch composite particles (thermoplastic starch).

### 6.4. Composition of Starch Composite Particles

The compositions of the obtained starch composite particles are shown in FIG. 5 (Table 1) to FIG. 11 (Table 7). In each table, a ratio of plasticizer/(starch, plasticizer), a ratio of crosslinking agent/(starch, plasticizer, crosslinking agent), and an average particle diameter of the starch composite particle are shown. For the measurement of the average particle diameter, a particle size distribution meter (Microtrac MT3000II, manufactured by Nikkiso Co., Ltd.) was used. The starch composite particles having different particle diameters were prepared by appropriately adjusting a supply rate, an inlet temperature, an outlet temperature, a residence time, the number of revolutions of an atomizer, a spray pressure, and the like of the mixed liquid (gelatinized liquid) in spray drying.

In Example 55, starch, a plasticizer, and a crosslinking agent were separately mixed without using starch composite particles. In Table 7, a content of the starch composite particles in Example 55 is underlined to indicate a total amount of the individual components, not a content of the starch composite particles.

### 7. Preparation of Composite

The hyphae, starch composite particles, crosslinking agent, and fibers were mixed to obtain mixing ratios shown in Tables 1 to 7. The hyphae used were shiitake mushroom hyphae with an average diameter of 3.0 μm and an average length of 0.1 mm, or polyporaceae hyphae with an average diameter of 5.0 μm and an average length of 0.5 mm. Cellulose fibers having an average diameter of 30 μm and an average length of 1.0 mm were used as raw materials for the fibers.

### 7.1. Preparation of Sheet Composite A

The sheet composite A was prepared as follows. First, a mixture in each example was hot-pressed at 150° C. for 2 minutes at a pressure of 90 MPa. Accordingly, a sheet-shaped sample (sheet composite A) was obtained.

### 7.2. Preparation of Sheet Composite B

The sheet composite B was prepared as follows. First, a mixture in each example was hot-pressed at 180° C. for 6 minutes at a pressure of 1 MPa. Accordingly, a sample (sheet composite B) having lower density than the sheet composite A was prepared.

### 8. Evaluation of Composite

### 8.1. Tensile Index

First, the sheet composite A was punched out to prepare a test piece. Next, using AUTOGRAPH AGC-X 500N (manufactured by Shimadzu Corporation), a tensile property test was performed on the test piece according to JIS P 8113:2006 to determine a tensile index. An obtained value was evaluated in view of the following evaluation criteria. Evaluation results are shown in each table.
A: Tensile index is 15 N·m/g or more
B: Tensile index is 10 N·m/g or more and less than 15 N·m/g
C: Tensile index is 5 Nm/g or more and less than 10 N·m/g
D: Tensile index is less than 5 N·m/g

### 8.2. Moisture Resistance

First, the sheet composite B was cut into a rectangular parallelepiped shape of 2 cm×1 cm×1 cm to prepare a test piece. An aluminum plate was placed inside a thermo-hygrostat, and test pieces were disposed at four corners. An aluminum plate weighing 800 g was placed thereon to apply a pressure of 0.01 MPa. After measuring an initial gap between the aluminum plates, an inside of the thermo-hygrostat was heated and humidified to 60° C. and 90% RH. After 120 hours, a gap between the aluminum plates was measured again, and a displacement rate from the initial gap (compressive creep rate) was determined. An obtained value was evaluated in view of the following evaluation criteria. Evaluation results are shown in each table.
A: Compressive creep rate is less than 5%
B: Compressive creep rate is 5% or more and less than 10%
C: Compressive creep rate is 10% or more and less than 20%
D: Compressive creep rate is 20% or more 8.3. Texture

The sheet composite B was subjected to sensory evaluation by 10 panelists (evaluators). The sensory evaluation was performed according to a ranking method for sensory evaluation analysis of JIS Z 9080:2004. Specifically, tactile feel of a surface of the sheet composite B was evaluated by 10 panelists in accordance with a 9-level preference scale defined in JIS Z 9080:2004. In particular, the tactile feel refers to a degree of smoothness and pleasant feeling to touch. The obtained preference scale was evaluated in view of the following evaluation criteria. Evaluation results are shown in each table. In the 9-level preference scale, 9 indicates most pleasant, and 1 indicates most unpleasant.
A: Preference scale is 8 to 9
B: Preference scale is 6 to 7
C: Preference scale is 4 to 5
D: Preference scale is 1 to 3

### 8. 4. Consideration

The following is recognized based on the evaluation results shown in Tables 1 to 7.
A composite having excellent mechanical strength, moisture resistance, and texture could be achieved by containing mushroom hyphae, starch, a plasticizer, a crosslinking agent, and a fiber.
In particular, it was confirmed that mechanical strength, moisture resistance, and texture were further enhanced by using starch composite particles.

What is claimed is:

1. A composite comprising:
mushroom hyphae;
starch;
a plasticizer;
a crosslinking agent; and
a fiber.

2. The composite according to claim 1, further comprising:
a starch composite particle in a form of a particle, wherein
the starch and the plasticizer are contained in the starch composite particle.

3. The composite according to claim 2, wherein
the crosslinking agent is contained in the starch composite particle.

4. The composite according to claim 2, wherein
an average particle diameter of the starch composite particle is 1 μm or more and 60 μm or less.

5. The composite according to claim 1, wherein
the fiber contains cellulose.

6. The composite according to claim 1, wherein
the crosslinking agent is crosslinked with the starch through the plasticizer.

7. The composite according to claim 1, wherein
the crosslinking agent is crosslinked with the hyphae.

8. The composite according to claim 1, wherein
the hyphae have an average diameter of 0.1 μm or more and 10.0 μm or less.

9. The composite according to claim 1, wherein
the fiber has an average diameter of 1.0 μm or more and 100.0 μm or less.

10. The composite according to claim 1, wherein
a mass ratio of a content of the hyphae to a content of the fiber is 0.10 or more and 9.0 or less.

11. The composite according to claim 1, wherein
a total content of the starch, the plasticizer, and the crosslinking agent is 1.0 mass % or more and 90.0 mass % or less.

12. The composite according to claim 1, wherein
the plasticizer is one or more selected from a sugar alcohol.

13. The composite according to claim 12, wherein
the sugar alcohol is one or more selected from sorbitol, erythritol, and D-mannitol.

14. The composite according to claim 1, wherein
a mass ratio of a content of the plasticizer to a total content of the plasticizer and the starch is 0.05 or more and 0.90 or less.

15. The composite according to claim 1, wherein
the crosslinking agent is one or more selected from a dicarboxylic acid.

16. The composite according to claim 15, wherein
the dicarboxylic acid is one or more selected from succinic acid, adipic acid, and sebacic acid.

17. A method for producing the composite according to claim 1, the method comprising:
defibrating a mushroom mycelium to obtain the hyphae; and
mixing the hyphae, the starch, the plasticizer, the crosslinking agent, and the fiber to obtain the composite.

18. A method for producing the composite according to claim 1, the method comprising:
preparing a medium including the starch, the plasticizer, the crosslinking agent, and the fiber;
inoculating the medium with an inoculum of the hyphae; and
culturing the inoculum to obtain the composite.

19. The method for producing the composite according to claim 18, wherein
the medium is a solid medium or a liquid medium.
